(19) United States
(12) Patent Application Publication
(10) Pub. No.: US 2008/0011725 A1
(43) Pub. Date: Jan. 17, 2008

(54) Laser beam processing machine

(75) Inventors: Toshio Tsuchiya, Tokyo (JP); Hiroshi Morikazu, Tokyo (JP)

Correspondence Address: SMITH, GAMBRELL & RUSSELL, 1130 CONNECTICUT AVENUE, N.W., SUITE 1130, WASHINGTON, DC, 20036, US

(73) Assignee: Disco Corporation

(21) Appl. No.: 11/822,974

(22) Filed: Jul. 11, 2007

(30) Foreign Application Priority Data
Jul. 13, 2006 (JP) 2006-192718

(51) Int. Cl. B23K 26/02; B23K 26/00

(52) U.S. Cl. 219/121.76

(57) ABSTRACT

A laser beam processing machine comprising a chuck table, a laser beam application means for applying a laser beam to a workpiece held on the chuck table, and a processing-feed means for moving the chuck table and the laser beam application means relative to each other in a processing-feed direction, wherein the laser beam application means comprises a first laser beam oscillation means for oscillating a first pulse laser beam having a wavelength ranging from a visible range to a near infrared range, a second laser beam oscillation means for oscillating a second pulse laser beam having a wavelength of an ultraviolet range, a delay means for delaying the timing of oscillating the second pulse laser beam a predetermined time after the timing of oscillating the first pulse laser beam and a common condenser for converging the first pulse laser beam and the second pulse laser beam.

### FIELD OF THE INVENTION

The present invention relates to a laser beam processing machine for carrying out laser processing along streets formed on a wafer such as a semiconductor wafer or the like.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a device such as IC, LSI or the like is formed in each of the sectioned areas. Individual semiconductor chips are manufactured by cutting this semiconductor wafer along the streets to divide it into the areas each having a device formed thereon. An optical device wafer having light receiving devices such as photodiodes or light emitting devices such as laser diodes laminated on the surface of a sapphire substrate is also cut along streets to be divided into individual optical devices such as photodiodes or laser diodes which are widely used in electric appliances.

As a means of dividing a wafer such as the above semiconductor wafer or optical device wafer along the streets, JP-A 10-305420 discloses a method in which a groove is formed by applying a pulse laser beam along the streets formed on a wafer and the wafer is divided along the grooves.

A wafer having devices whose surfaces are covered with an insulating film made of silicon dioxide (SiO₂) or the like has a problem that the insulating film peels off by the application of a laser beam and hence, damages the devices or reduces the quality of each chip.

### SUMMARY OF THE INVENTION

It is an object of the present invention to provide a laser beam processing machine capable of forming a groove along streets without peeling off an insulating film even when the insulating film is formed on the front surface of a wafer.

To attain the above object, according to the present invention, there is provided a laser beam processing machine comprising a chuck table for holding a workpiece, a laser beam application means for applying a laser beam to the workpiece held on the chuck table, a processing-feed means for moving the chuck table and the laser beam application means relative to each other in a processing-feed direction and an indexing-feed means for moving the chuck table and the laser beam application means in an indexing-feed direction perpendicular to the processing-feed direction, wherein

the laser beam application means comprises a first laser beam oscillation means for oscillating a first pulse laser beam having a wavelength ranging from a visible range to a near infrared range, a second laser beam oscillation means for oscillating a second pulse laser beam having a wavelength of an ultraviolet range, a delay means for delaying the timing of oscillating the second pulse laser beam from the second laser beam oscillation means a predetermined time after the timing of oscillating the first pulse laser beam from the first laser beam oscillation means and a common condenser for converging the first pulse laser beam and the second pulse laser beam.

The above laser beam application means comprises a common repetition frequency setting means for setting the repetition frequency of the first pulse laser beam oscillated from the first laser beam oscillation means and the repetition frequency of the second pulse laser beam oscillated from the second laser beam oscillation means, and the delay means delays the timing of oscillating the second pulse laser beam from the second laser beam oscillation means a predetermined time.

The delay time by the above delay means is set to 50 to 300 ns, preferably 100 to 200 ns.

In the laser beam processing machine of the present invention, the first pulse laser beam is oscillated from the first laser beam oscillation means before the second pulse laser beam oscillated from the second laser beam oscillation means. By applying the first pulse laser beam that is oscillated from the first laser beam oscillation means and has a wavelength ranging from a visible range to a near infrared range, the area to be processed of the workpiece is preheated to be softened. Since the second pulse laser beam that is oscillated from the second laser beam oscillation means and has a wavelength of an ultraviolet range is applied to this softened area, even when an insulating film is formed on the front surface of the workpiece, it does not peel off by the application of the second pulse laser beam.

### BRIEF DESCRIPTION OF THE DRAWINGS

FIG. 1 is a perspective view of a laser beam processing machine constituted according to the present invention;

FIG. 2 is a block diagram of laser beam application means provided in the laser beam processing machine shown in FIG. 1;

FIG. 3 is a perspective view showing a state where a semiconductor wafer as a workpiece is mounted on a frame through a protective tape;

FIG. 4 is an enlarged sectional view of the principal section of the semiconductor wafer shown in FIG. 3;

FIG. 5 is an explanatory diagram showing a laser beam application step for laser processing the semiconductor wafer with the laser beam processing machine shown in FIG. 1; and

FIG. 6 is an enlarged sectional view of the principal section of the semiconductor wafer which has been processed with the laser beam processing machine shown in FIG. 1.

### DETAILED DESCRIPTION OF THE PREFERRED EMBODIMENT

A preferred embodiment of the present invention will be described in more detail with reference to the accompanying drawings.

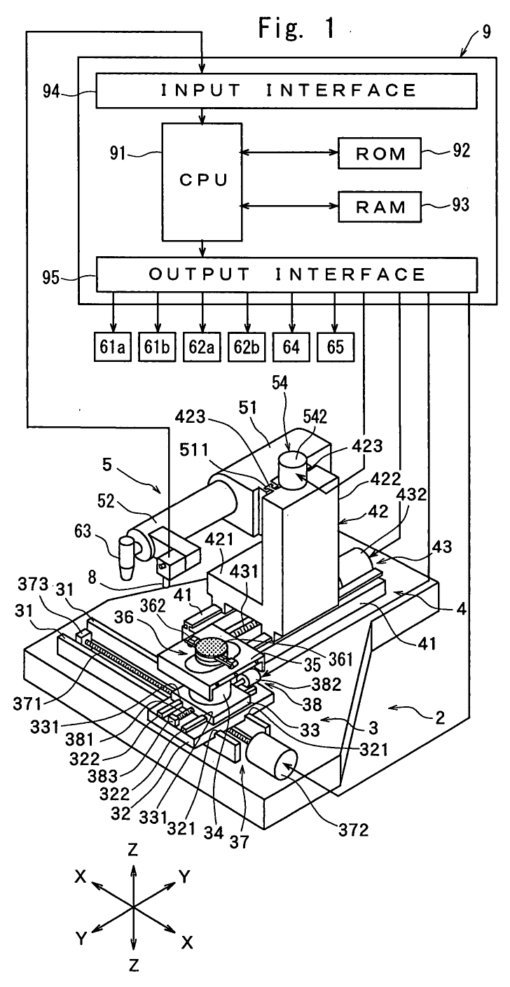

FIG. 1 is a perspective view of a laser beam processing machine constituted according to the present invention. The laser beam processing machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4 mounted on the stationary base 2 in such a manner that it can move in an indexing-feed direction indicated by an arrow Y perpendicular to the direction indicated by the arrow X, and a laser beam application unit 5 mounted on the laser beam application unit support mechanism 4 in such a manner that it can move in a direction indicated by an arrow Z.

The above chuck table mechanism 3 comprises a pair of guide rails 31 and 31 mounted on the stationary base 2 and arranged parallel to each other in the processing-feed direction indicated by the arrow X, a first sliding block 32 mounted on the guide rails 31 and 31 in such a manner that it can move in the processing-feed direction indicated by the arrow X, a second sliding block 33 mounted on the first sliding block 32 in such a manner that it can move in the indexing-feed direction indicated by the arrow Y, a cover table 35 supported on the second sliding block 33 by a cylindrical member 34, and a chuck table 36 as a workpiece holding means. This chuck table 36 comprises an adsorption chuck 361 made of a porous material, and a workpiece, for example, a disk-like wafer is held on the adsorption chuck 361 by a suction means that is not shown. The chuck table 36 constituted as described above is rotated by a pulse motor (not shown) installed in the cylindrical member 34. The chuck table 36 is provided with clamps 362 for fixing an annular frame which will be described later.

The above first sliding block 32 has, on its undersurface, a pair of to-be-guided grooves 321 and 321 to be fitted to the above pair of guide rails 31 and 31 and has, on the top surface, a pair of guide rails 322 and 322 formed parallel to each other in the indexing-feed direction indicated by the arrow Y. The first sliding block 32 constituted as described above can move along the pair of guide rails 31 and 31 in the processing-feed direction indicated by the arrow X by fitting the to-be-guided grooves 321 and 321 to the pair of guide rails 31 and 31, respectively. The chuck table mechanism 3 in the illustrated embodiment comprises a processing-feed mechanism 37 for moving the first sliding block 32 along the pair of guide rails 31 and 31 in the processing-feed direction indicated by the arrow X. The processing-feed mechanism 37 comprises a male screw rod 371 arranged between the above pair of guide rails 31 and 31 in parallel thereto and a drive source such as a pulse motor 372 for rotary-driving the male screw rod 371. The male screw rod 371 is, at its one end, rotatably supported to a bearing block 373 fixed on the above stationary base 2 and is, at the other end, transmission-coupled to the output shaft of the above pulse motor 372. The male screw rod 371 is screwed into a threaded through-hole formed in a female screw block (not shown) projecting from the undersurface of the center portion of the first sliding block 32. Therefore, by driving the male screw rod 371 in a normal direction or adverse direction with the pulse motor 372, the first sliding block 32 is moved along the guide rails 31 and 31 in the processing-feed direction indicated by the arrow X.

The above second sliding block 33 has, on its undersurface, a pair of to-be-guided grooves 331 and 331 to be fitted to the pair of guide rails 322 and 322 on the top surface of the above first sliding block 32 and can move in the indexing-feed direction indicated by the arrow Y by fitting the to-be-guided grooves 331 and 331 to the pair of guide rails 322 and 322, respectively. The chuck table mechanism 3 in the illustrated embodiment comprises a first indexing-feed mechanism 38 for moving the second sliding block 33 along the pair of guide rails 322 and 322 on the first sliding block 32 in the indexing-feed direction indicated by the arrow Y. The first indexing-feed mechanism 38 comprises a male screw rod 381 which is arranged between the above pair of guide rails 322 and 322 in parallel thereto and a drive source such as a pulse motor 382 for rotary-driving the male screw rod 381. The male screw rod 381 is, at its one end, rotatably supported to a bearing block 383 fixed on the top surface of the above first sliding block 32 and is, at the other end, transmission-coupled to the output shaft of the above pulse motor 382. The male screw rod 381 is screwed into a threaded through-hole formed in a female screw block (not shown) projecting from the undersurface of the center portion of the second sliding block 33. Therefore, by driving the male screw rod 381 in a normal direction or adverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 mounted on the stationary base 2 and arranged parallel to each other in the indexing-feed direction indicated by the arrow Y and a movable support base 42 mounted on the guide rails 41 and 41 in such a manner that it can move in the direction indicated by the arrow Y. This movable support base 42 consists of a movable support portion 421 movably mounted on the guide rails 41 and 41 and a mounting portion 422 mounted on the movable support portion 421. The mounting portion 422 is provided with a pair of guide rails 423 and 423 extending parallel to each other in the direction indicated by the arrow Z on one of its flanks. The laser beam application unit support mechanism 4 in the illustrated embodiment has a second indexing-feed mechanism 43 for moving the movable support base 42 along the pair of guide rails 41 and 41 in the indexing-feed direction indicated by the arrow Y. This second indexing-feed mechanism 43 comprises a male screw rod 431 arranged between the above pair of guide rails 41 and 41 in parallel thereto and a drive source such as a pulse motor 432 for rotary-driving the male screw rod 431. The male screw rod 431 is, at its one end, rotatably supported to a bearing block (not shown) fixed on the above stationary base 2 and is, at the other end, transmission-coupled to the output shaft of the above pulse motor 432. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or adverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51, a cylindrical casing 52 secured to the unit holder 51 and a laser beam application means later described installed in the casing 52. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the to-be-guided grooves 511 and 511 to the above guide rails 423 and 423, respectively.

The laser beam application unit 5 in the illustrated embodiment comprises a moving mechanism 54 for moving the unit holder 51 along the pair of guide rails 423 and 423 in the direction indicated by the arrow Z. The moving mechanism 54 comprises a male screw rod (not shown) arranged between the pair of guide rails 423 and 423 and a drive source such as a pulse motor 542 for rotary-driving the male screw rod. By driving the male screw rod (not shown) in a normal direction or adverse direction with the pulse motor 542, the casing 52 which is secured to the unit holder 51 and has a first laser beam application means and a second laser beam application means (which will be described later) installed therein is moved along the guide rails 423 and 423 in the direction indicated by the arrow Z. In the illustrated embodiment, the casing 52 is moved up by driving the pulse motor 542 in a normal direction and moved down by driving the pulse motor 542 in the adverse direction.

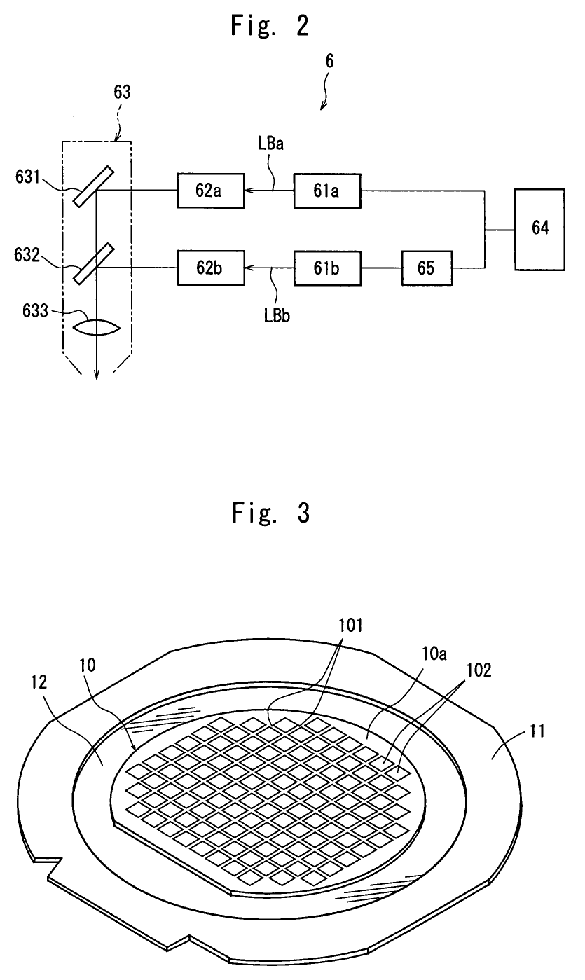

The laser beam application means installed in the above casing 52 will be described with reference to FIG. 2.

The laser beam application means 6 in the illustrated embodiment shown in FIG. 2 comprises a first pulse laser beam oscillation means 61a, a second pulse laser beam oscillation means 61b, a first output adjustment means 62a for adjusting the output of a first pulse laser beam LBa oscillated from the first pulse laser beam oscillation means 61a, a second output adjustment means 62b for adjusting the output of a second pulse laser beam LBb oscillated from the second pulse laser beam oscillation means 61b, and a common condenser 63 for converging the first pulse laser beam LBa and the second pulse laser beam LBb.

The above first pulse laser beam oscillation means 61a oscillates a pulse laser beam having a wavelength ranging from a visible range to a near infrared range (380 to 4,000 nm, preferably 600 to 2,500 nm). The first pulse laser beam oscillation means 61a in the illustrated embodiment is composed of a YAG laser oscillator or a YVO4 laser oscillator and oscillates the first pulse laser beam LBa of a near infrared range having a wavelength of 1,064 nm, for example.

The above second pulse laser beam oscillation means 61b oscillates a pulse laser beam having a wavelength of an ultraviolet range (266 to 355 nm). The second pulse laser beam oscillation means 61b in the illustrated embodiment is composed of a YAG laser oscillator or a YVO4 laser oscillator and oscillates the second pulse laser beam LBb having a wavelength of 355 nm, for example.

The above first output adjustment means 62a and the above second output adjustment means 62b adjust the output of the first pulse laser beam LBa oscillated from the first pulse laser beam oscillation means 61a and the output of the second pulse laser beam LBb oscillated from the second pulse laser beam oscillation means 61b based on a control instruction from a control means which will be described later, respectively, and supply these pulse laser beams to the condenser 63.

The above condenser 63 comprises a first direction changing mirror 631, a second direction changing mirror 632 and an objective condenser lens 633. A total reflection mirror is used as the first direction changing mirror 631 and changes the direction of the first pulse laser beam LBa oscillated from the above first pulse laser beam oscillation means 61a to a direction toward the objective condenser lens 633. The second direction changing mirror 632 is interposed between the first direction changing mirror 631 and the objective condenser lens 633. This second direction changing mirror 632 is composed of a photosynthesizing mirror (dichroic mirror) coated with a dielectric multi-layer film which totally reflects the second pulse laser beam LBb having a wavelength of 355 nm and transmits all of the first pulse laser beam LBa having a wavelength of 1,064 nm. Therefore, the second direction changing mirror 632 changes the direction of the second pulse laser beam LBb oscillated from the above second pulse laser beam oscillation means 61b to a direction toward the objective condenser lens 633 and transmits the first pulse laser beam LBa having a wavelength of 1,064 nm whose direction has been changed by the above first direction changing mirror 631. In the above illustrated embodiment, a quartz lens having a transmission wavelength range of 200 to 2,700 nm is used as the above objective condenser lens 633. Therefore, the objective condenser lens 633 can focus the first pulse laser beam LBa having a wavelength of 1,064 nm and the second pulse laser beam LBb having a wavelength of 355 nm on the same axis. The condenser 63 constituted as described above is mounted on the front end of the casing 52 as shown in FIG. 1.

The laser beam application means 6 in the illustrated embodiment shown in FIG. 2 comprises a common repetition frequency setting means 64 which sets the repetition frequency of the first pulse laser beam LBa oscillated from the first pulse laser beam oscillation means 61a and the repetition frequency of the second pulse laser beam LBb oscillated from the second pulse laser beam oscillation means 61b. Preferably, the laser beam application means 6 in the illustrated embodiment shown in FIG. 2 comprises a delay means 65 for delaying the timing of oscillating the second pulse laser beam LBb from the second pulse laser beam oscillation means 61b a predetermined time after the timing of oscillating the first pulse laser beam LBa from the first pulse laser beam oscillation means 61a. The delay time by this delay means 65 is preferably set to 50 to 300 ns. The delay time by the delay means 65 is more preferably set to 100 to 200 ns.

Returning to FIG. 1, an image pick-up means 8 for detecting the area to be processed with the first pulse laser beam LBa oscillated from the first pulse laser beam oscillation means 61a and the second pulse laser beam LBb oscillated from the second pulse laser beam oscillation means 61b is mounted on the front end portion of the above casing 52. This image pick-up means 8 is constituted by an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for picking up an image with visible radiation in the illustrated embodiment, and even when the area to be processed cannot be recognized with visible radiation, it can be detected. An image signal is supplied to the control means that will be described later.

The laser beam processing machine in the illustrated embodiment comprises the control means 9. The control means 9 is composed of a computer comprising a central processing unit (CPU) 91 for carrying out arithmetic processing based on a control program, a read-only memory (ROM) 92 for storing the control program, etc., a read/write random access memory (RAM) 93 for storing the results of operations, an input interface 94 and an output interface 95. A detection signal from the above image pick-up means 8 is input to the input interface 95 of the control means 9. From the output interface 95 of the control means 9, control signals are output to the above pulse motor 372, the pulse motor 382, the pulse motor 432, the pulse motor 542, the first pulse laser beam oscillation means 61a, the second pulse laser beam oscillation means 61b, the first output adjustment means 62a, the second output adjustment means 62b, the repetition frequency setting means 64 and the delay means 65.

The laser beam processing machine in the illustrated embodiment is constituted as described above, and its function will be described hereinbelow.

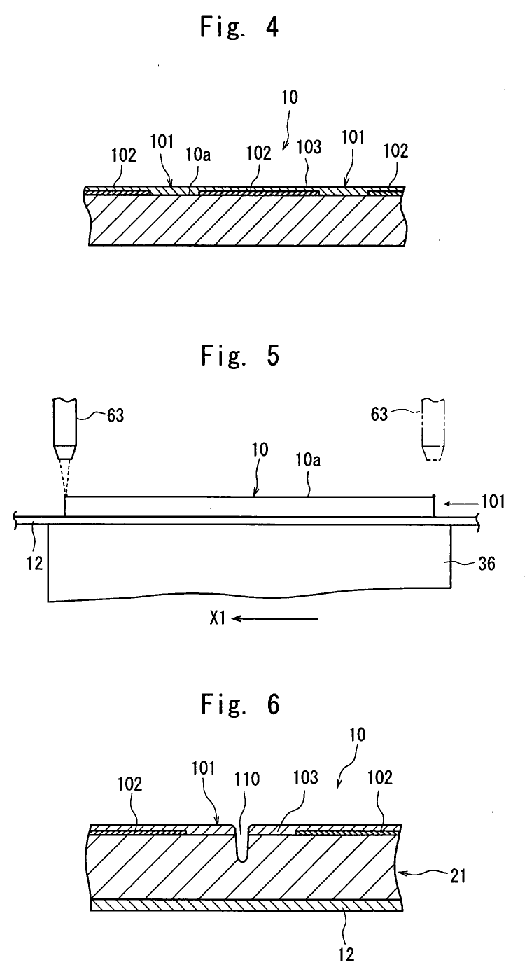

The semiconductor wafer as the workpiece to be processed by the above laser beam processing machine will be described with reference to FIG. 3 and FIG. 4. The semiconductor wafer 10 shown in FIG. 3 and FIG. 4 is, for example, a silicon wafer having a thickness of 80 μm, a plurality of areas are sectioned by a plurality of streets 101 arranged in a lattice pattern on the front surface 10a of the silicon wafer, and a device 102 such as IC or LSI is formed in each of the sectioned areas. An insulating film 103, which is layered of SiO₂, Cu and SiO₂ and has a thickness of about 5 μm, is formed on the front surface 10a of the semiconductor wafer 10, as shown in FIG. 4. The rear surface of the semiconductor wafer 10 constituted as described above is put on a protective tape 12 formed of a synthetic resin sheet such as a polyolefin sheet mounted on an annular frame 11 as shown in FIG. 3 in such a manner that the front surface 10a faces up.

The laser processing method which is carried out along the streets 101 of the above semiconductor wafer 10 by using the laser beam processing machine shown in FIG. 1 and FIG. 2 will be described hereinbelow.

To carry out laser processing along the streets 101 of the above semiconductor wafer 10, the semiconductor wafer 10 shown in FIG. 3 is first placed on the chuck table 36 of the laser beam processing machine shown in FIG. 1 in such a manner that the front surface 10a faces up and suction-held on the chuck table 36. The annular frame 11 on which the protective tape 12 is mounted is fixed by the clamps 362 provided in the chuck table 36.

The chuck table 36 suction-holding the semiconductor wafer 10 as described above is brought to a position right below the image pick-up means 8 by the processing-feed mechanism 37. After the chuck table 36 is positioned right below the image pick-up means 8, alignment work for detecting the area to be processed of the semiconductor wafer 10 is carried out by the image pick-up means 8 and the control means 9. That is, the image pick-up means 8 and the control means 9 carry out image processing such as pattern matching, etc. to align a street 101 formed in a predetermined direction of the semiconductor wafer 10 with the above condenser 63, thereby performing the alignment of a laser beam application position. The alignment of the laser beam application position is also carried out on streets 101 formed on the semiconductor wafer 10 in a direction perpendicular to the above predetermined direction.

After the alignment of the laser beam application position is carried out by detecting the street 101 formed on the semiconductor wafer 10 held on the chuck table 36 as described above, the chuck table 51 is moved to a laser beam application area where the condenser 63 is located so as to bring the predetermined street 101 to a position right below the condenser 63 as shown in FIG. 5. At this point, the semiconductor wafer 10 is positioned such that one end (left end in FIG. 5) of the street 101 is located right below the condenser 63. The control means 9 supplies then control signals to the first pulse laser beam oscillation means 61a, the second pulse laser beam oscillation means 61b, the first output adjustment means 62a, the second output adjustment means 62b, the repetition frequency setting means 64 and the delay means 65 to apply the first pulse laser beam LBa and the second pulse laser beam LBb from the condenser 63 and controls the processing-feed mechanism 37 to move the chuck table 36 at a predetermined processing-feed rate in the direction indicated by the arrow X1 in FIG. 5 (laser beam application step). When the other end (right end in FIG. 5) of the street 101 then reaches a position right below the condenser 63, the application of the pulse laser beams is suspended and the movement of the chuck table 36 is stopped.

The processing conditions in the above laser beam application step will be described hereinbelow.
(1) first laser beam application means 61a:
   light source: YAG laser
   wavelength: 1,064 nm
   repetition frequency: 10 kHz
   average output: 17 W
   focal spot diameter: 20 to 40 μm
(2) second laser beam application means 61b
   light source: YAG laser
   wavelength: 355 nm
   repetition frequency: 10 kHz
   average output: 0.5 W
   focal spot diameter: 10 to 15 μm
(3) processing-feed rate: 150 mm/sec
(4) delay time: 100 to 200 ns

Under the above processing conditions, the first pulse laser beam LBa is oscillated from the first pulse laser beam oscillation means 61a 100 to 200 nm before the second pulse laser beam LBb is oscillated from the second pulse laser beam oscillation means 61b. The average output of the first pulse laser beam LBa having a wavelength of 1,064 nm (having permeability for a silicon wafer) oscillated from the first pulse laser beam oscillation means 61a is adjusted to 17 W by the first output adjustment means 62a, and the first pulse laser beam LBa is converged by the objective condenser lens 633 through the first direction changing mirror 631 and the second direction changing mirror 632 and applied to the surface of the street 101 of the semiconductor wafer 10. Therefore, the surface of the street 101 is pre-heated at about 1,000° C. by the energy of the first pulse laser beam LBa. As a result, the insulating film 103 formed on the front surface 10a of the semiconductor wafer 10 is softened.

Meanwhile, the average output of the second pulse laser beam LBb having a wavelength of 355 nm which is oscillated from the second pulse laser beam oscillation means 61b 100 to 200 nm after the first pulse laser beam LBa is adjusted to 0.5 W by the second output adjustment means 62b, and the second pulse laser beam LBb is converged by the objective condenser lens 633 through the second direction changing mirror 632 and applied to the surface of the street 101 of the semiconductor wafer 10. Since the second pulse laser beam LBb has an ultraviolet wavelength of 355 nm and absorptivity for a silicon wafer, a groove 110 is formed along the street 101 in the semiconductor wafer 10 as shown in FIG. 6. At this point, the insulating film 103 formed on the front surface 10a of the semiconductor wafer 10 is softened by the application of the first pulse laser beam LBa, even when the second pulse laser beam LBb is applied, the insulating film 103 does not peel off.

After the above laser beam application step is carried out along all the streets 101 formed in the predetermined direction of the semiconductor wafer 10, the chuck table 36 is turned at 90° to turn the semiconductor wafer 10 held on the chuck table 36 at 90°. The above laser beam application step is carried out along all the streets formed in the direction perpendicular to the above predetermined direction of the semiconductor wafer 10.

After the above laser beam application step is carried out along all the streets 101 formed on the semiconductor wafer 10, the semiconductor wafer 10 is carried to the subsequent dividing step.

What is claimed is:

1. A laser beam processing machine comprising a chuck table for holding a workpiece, a laser beam application means for applying a laser beam to the workpiece held on the chuck table, a processing-feed means for moving the chuck table and the laser beam application means relative to each other in a processing-feed direction and an indexin-feed means for moving the chuck table and the laser beam application means in an indexing-feed direction perpendicular to the processing-feed direction, wherein
the laser beam application means comprises a first laser beam oscillation means for oscillating a first pulse laser beam having a wavelength ranging from a visible range to a near infrared range, a second laser beam oscillation means for oscillating a second pulse laser beam having a wavelength of an ultraviolet range, a delay means for delaying the timing of oscillating the second pulse laser beam from the second laser beam oscillation means a predetermined time after the timing of oscillating the first pulse laser beam from the first laser beam oscillation means and a common condenser for converging the first pulse laser beam and the second pulse laser beam.

2. The laser beam processing machine according to claim 1, wherein the laser beam application means comprises a common repetition frequency setting means for setting the repetition frequency of the first pulse laser beam oscillated from the first laser beam oscillation means and the repetition frequency of the second pulse laser beam oscillated from the second laser beam oscillation means, and the delay means delays the timing of oscillating the second pulse laser beam from the second laser beam oscillation means a predetermined time.

3. The laser beam processing machine according to claim 1 or 2, wherein the delay time by the delay means is set to 50 to 300 ns.

4. The laser beam processing machine according to claim 3, wherein the delay time by the delay means is set to 100 to 200 ns.
